(19) United States
(12) Patent Application Publication
(10) Pub. No.: US 2011/0187113 A1
(43) Pub. Date: Aug. 4, 2011

(54) HYDRO-ELECTRIC SYSTEM AND DEVICE FOR PRODUCING ENERGY

(76) Inventor: Gary Loo, Toronto, CA (US)

(21) Appl. No.: 12/699,963

(22) Filed: Feb. 4, 2010

(51) Int. Cl. F03B 13/10; F03B 17/04

(52) U.S. Cl. 290/54; 415/916

(57) ABSTRACT

An energy producing unit is provided for producing energy from an artificial fall of fluid. The energy producing unit includes a host structure immersed in a fluid and a chamber positioned relative to the host structure such that the bottom wall of the chamber is immersed in the fluid. The chamber is vertically movable between a risen position and a lowered position and is buoyantly biased to the risen position when empty. The chamber has a primary valve which divides the chamber into an upper and lower portion to control the flow of fluid between the portions. The energy producing unit includes a conduit in communication with the upper chamber portion and an energy extraction disposed within the conduit. As fluid flows through the conduit into the chamber, energy is extracted from the flowing fluid. The invention also includes a system of at least two energy producing units.

### FIELD OF THE INVENTION

This invention generally relates to an apparatus and system for producing energy. More specifically, to apparatuses and systems that utilize a falling volume of water to produce energy.

### BACKGROUND OF THE INVENTION

Energy has been traditionally derived from the burning of fossil fuels, such as coal, oil and gas. However, an increasing demand for energy has resulted in the depletion of natural resources and increased cost for energy. Environmental concerns have also been raised over the release of harmful pollutants from using energy stored in fossil fuels. Nuclear power is another energy source, but there are concerns about safety and disposal of nuclear waste byproducts. Alternative sources of energy such as wind power and solar power are not presently believed to provide a cost effective and base load energy source on demand.

Hydro-electric energy is a safe, cost effective and renewable base load energy source. Hydro-electric power generation typically involves the use of falling water (either naturally occurring or dammed) to drive turbines which in turn drive generators to generate energy. However, the available sites in the world to utilize this resource have almost all been developed over the years.

Artificial falls of water may be created to mimic the capture of kinetic energy from falling water. Fallen water collected in artificial basins must be dispersed. However, energy is typically used to disperse the fallen water, which is inefficient. Water dispersion methods have been suggested such as the use of a pump, vacuum or water vaporization to remove the fallen water.

It would be desirable to provide an energy producing unit which requires less energy to disperse fallen water than that captured by the kinetic energy of the fallen water.

### SUMMARY OF THE INVENTION

According to a first aspect of the invention, an energy producing unit is provided. The host structure is immersed in a fluid. A chamber, having a bottom wall, is positioned relative to the host structure such that the bottom wall of the chamber is immersed. The chamber is independently vertically movable relative to the host structure between a risen position and a lowered position. The chamber is buoyantly biased to the risen position when empty. The primary valve member has a primary valve and a fluid seal. The primary valve member is disposed within the chamber in a fixed position relative to the host structure to divide the chamber into an upper portion and a lower portion. The fluid seal is disposed between the primary valve member and the chamber. When the primary valve is open, fluid may pass between the upper and lower portions and when closed, prevents fluid communication between such portions. A chamber valve is in the lower portion of the chamber for draining fluid from the chamber. A conduit has a first end and a second end. The conduit is in fluid communication with the upper portion of the chamber at the first end and is open to the exterior of the chamber at the second end. The conduit permits fluid located outside the chamber to flow into the upper portion of the chamber. The conduit has at least one conduit valve for controlling the flow of the fluid into the chamber. An energy extraction device is disposed within the conduit to extract kinetic energy as fluid flows through the conduit into the chamber. A support frame is disposed relative to the host structure to support the primary valve member in a fixed position relative to the host structure without interfering with the movement of the chamber.

When the chamber is in the risen position and fluid fills the chamber, by opening the primary valve, the chamber sinks due to its increased weight to the lowered position. When the chamber is in the lowered position, by closing the primary valve and opening the chamber valve, fluid drains from the chamber, and the chamber rises due to buoyant forces to the risen position.

In the alternative, the chamber may be immersed within the host structure.

The fluid may be water.

The host structure may have at least one side wall and the conduit may pass through the at least one side wall of the host structure. The host structure may have a bottom wall and the chamber may move from the risen position to the lowered position through a scaled opening in the bottom wall of the host structure. The scaled opening has a fluid seal.

The energy producing unit may have a weight member to adjust a downward gravitational force on the chamber.

The energy producing unit may have stabilizers affixed to the host structure to stabilize vertical movement of the chamber.

The conduit may have a flexible portion. The flexible portion of the conduit may be in communication with the upper portion of the chamber.

The conduit may have an extendible portion. The extendible portion of the conduit may be in communication with the upper portion of the chamber.

The energy extraction device may be a turbine. The energy extraction may be connected to a generator for generating electrical energy.

Various configurations are possible for the support frame. The support frame may be disposed within the host structure, or suspended within the host structure. The support frame may be affixed to the host structure or anchored adjacent to the host structure.

The energy producing unit may have a lift to assist the chamber to vertically move from the lowered position to the risen position.

A second energy extraction device may be disposed on the outer surface of the chamber. The second energy extraction device may be connected to a generator for generating electrical energy.

The chamber may have expansion wings disposed on the bottom surface of the chamber.

The chamber may have an expansion arm vertically affixed to the bottom surface of the chamber.

The energy producing unit may have controls. The controls may control the opening and closing of the valves, the opening and closing of the partition, the vertical movement of the chamber or the extension and retraction of expansion wings and expansion arms.

According to another aspect of the invention, an energy producing structure is provided. The energy producing structure has at least two energy producing units. Each energy producing unit has:
a host structure having at least one side wall, the host structure immersed in a fluid;
a chamber having a bottom wall, the chamber positioned relative to the host structure such that the bottom wall of the chamber is immersed, the chamber being independently vertically movable relative to the host structure between a risen position and a lowered position, the chamber buoyantly biased to the risen position when empty;
a primary valve member having a primary valve and a fluid seal, the primary valve disposed within the chamber in a fixed position relative to the host structure to divide the chamber into an upper portion and a lower portion, the fluid seal disposed between the primary valve member and the chamber, such that when the primary valve is open, fluid may pass between the upper and lower portions and when closed, prevents fluid communication between such portions;
a chamber valve in the lower portion of the chamber such that the chamber valve is immersed for draining fluid from the chamber;
a support frame affixed to the host structure to support at least one primary valve member in a fixed position relative to the host structure without interfering with the movement of the chamber; and
a weight member affixed to the chamber to adjust a downward gravitational force on the chamber.

The energy producing structure also has at least two conduits passing through the at least one side wall of the host structure. Each conduit has a first end and a second end. A first conduit is in fluid communication with the upper portion of the chamber at the first end and is open to the exterior of a first chamber at the second end. A second conduit in fluid communication with the first conduit at the first end and is open to the exterior of a second chamber at the second end. The at least two conduits permit fluid located outside the chamber to flow into the upper portion of the chambers. The at least two conduits have at least one valve for controlling the flow of the fluid into the chamber.

The energy producing structure also has at least one energy extraction device disposed within the at least two conduits to extract kinetic energy as fluid flows through the at least two conduits into the chambers.

When the chambers are in the risen position and fluid fills the chambers, by opening the primary valve, the chambers sink due to their increased weight to the lowered position. When the chambers are in the lowered position, by closing the primary valve and opening the chamber valve, fluid drains from the chambers, and the chambers rise due to buoyant forces to the risen position.

The host structure of each energy producing unit may have a bottom wall. The chamber of each energy producing unit may move from the risen position to the lowered position through a scaled opening in the bottom wall of the host structure. The scaled openings have fluid seals.

The second ends of the conduits may have a flexible portion in communication with the upper portion of the chamber.

The second ends of the conduits may have an extendible portion in communication with the upper portion of the chamber.

The energy producing structure may have stabilizers affixed to the host structure of each energy producing unit to stabilize vertical movement of the chambers.

The energy producing structure may have controls to control the opening and closing of the valves.

### BRIEF DESCRIPTION OF THE DRAWINGS

FIG. 1 is a cross-sectional side view of an energy producing unit at a first stage of an energy production cycle, in accordance with a first embodiment of the present invention.

FIG. 2 is a cross-sectional side view of an energy producing unit at a second stage of an energy production cycle, in accordance with a first embodiment of the present invention.

FIGS. 3A-3B are cross-sectional side views of an energy producing unit at a third stage of an energy production cycle, in accordance with a first embodiment of the present invention.

FIG. 4 is a cross-sectional side view of an energy producing unit at a fourth stage of an energy production cycle, in accordance with a first embodiment of the present invention.

FIGS. 5A-5B are cross-sectional side views of a chamber of an energy producing unit with expansion wings, in accordance with a first embodiment of the present invention.

FIGS. 6A-6B are cross-sectional side views of a chamber of an energy producing unit with an expansion arm, in accordance with a first embodiment of the present invention.

FIG. 7 is a cross-sectional side view of an energy producing unit at a first stage of an energy production cycle, in accordance with a second embodiment of the present invention.

FIG. 8 is a cross-sectional side view of an energy producing unit at a first stage of an energy production cycle, in accordance with a third embodiment of the present invention.

FIG. 9 is a cross-sectional side view of an energy producing unit at a third stage of an energy production cycle, in accordance with a third embodiment of the present invention.

FIG. 10 is a top plan view of an energy producing system, in accordance with the present invention.

### DETAILED DESCRIPTION OF THE PREFERRED EMBODIMENTS

An energy producing unit is provided to capture kinetic energy of falling fluid into an empty chamber. The fallen fluid is dispersed efficiently by using less energy than that captured by the extraction device. The extracted energy may be connected to a generator to produce electricity or serve as an energy source.

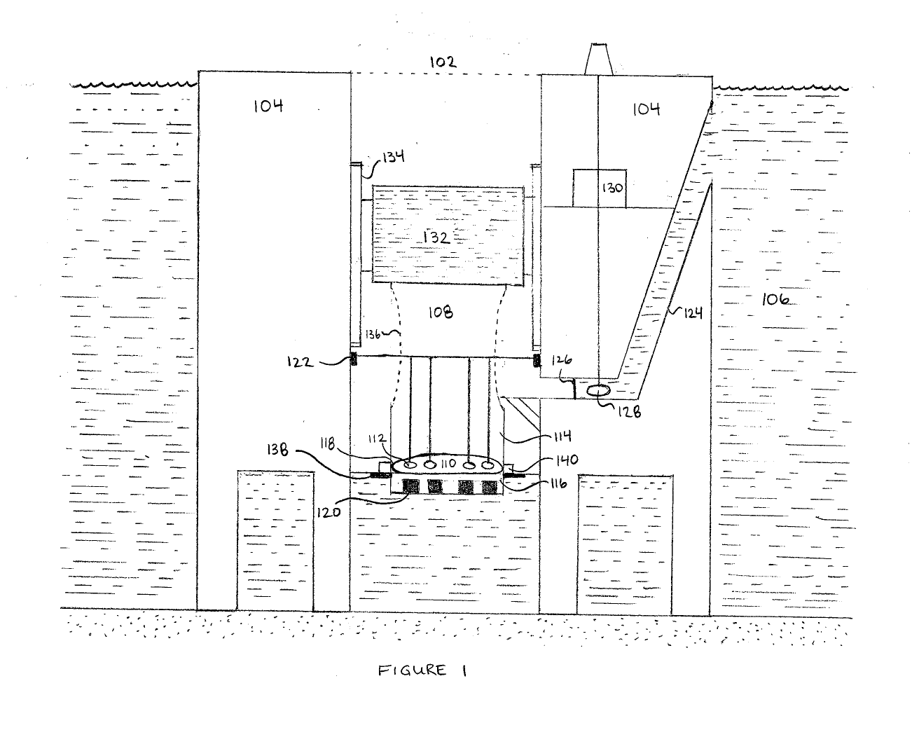

FIGS. 1 to 4 illustrate a cross-sectional view of an energy producing unit 102 at various stages of an energy production cycle according to one embodiment of the present invention. The energy producing unit 102 has a host structure 104 comprised of at least one sidewall and a bottom wall which form a basin. The host structure 104 is immersed in a fluid 106. A chamber 108 is positioned within the host structure 104.

A primary valve member 110 is located within the chamber 108 and divides the chamber 108 into an upper chamber portion 114 and a lower chamber portion 116. The primary valve member 110 includes primary valves 112 to trap fallen fluid in the lower chamber portion 116, when closed and to allow the fluid to flow from the upper chamber portion 114 to the lower chamber portion 116 when open. The upper chamber portion 114 has chamber openings 136 to permit the flow of fluid into the chamber 108.

In order to seal the fluid in the lower chamber portion 116, the primary valve member 110 which is fixed within the vertically moveable chamber 108 may include a primary valve seal 118 therebetween extending around the perimeter of the primary valve member 110. The primary valve seal 118 is adapted to prevent the seepage of fluid between the primary valve member 110 and the chamber 108, while the chamber 108 remains vertically moveable. The primary valve seal 118 may be constructed of any suitable material, such that the coefficient of friction between the primary valve seal 118 and the chamber 108 is just sufficient to prevent water passage between the upper and lower portions of the chamber but permit an almost unhindered vertical movement of the chamber. The primary valve seal 118 may be a dynamic seal.

A conduit 124 passes through a side wall of the host structure 104 in fluid communication with the upper chamber portion 114 at a first end and with the fluid at a second end to allow fluid to flow into the chamber 108. A conduit valve 126 is attached to the conduit 124 to control the flow of the fluid into the chamber 108 through the chamber openings 136. The conduit valve 126 may be placed anywhere within the conduit 124. To improve control of fluid, a second conduit valve may be positioned at the mouth of the conduit.

A support frame 122 is fixed to the host structure 104 at one end and passes through the chamber openings 136 in the upper chamber portion 114. The support frame 122 is connected to the primary valve member 110 at the other end and holds the primary valve member 110 in a fixed position within the chamber 108.

A chamber valve 120 is located in the lower chamber portion 116 to trap fallen fluid in the chamber 108 when closed and to allow fluid to drain from the chamber 108 when open.

An energy extraction device 128 is positioned within the conduit 124 to extract kinetic energy as the fluid flows through the conduit 124 into the chamber 108. The energy extraction device 128 may be a turbine or device for capturing kinetic energy. The energy extraction device 128 may be placed anywhere within the conduit 124.

The energy extraction device 128 may be connected to a generator 130 for generating electricity. The energy extraction device 128 may also be connected to a device for direct energy consumption.

As shown in FIG. 1, when the chamber 108 is empty, the chamber is buoyantly biased to a risen position and the chamber valves 120 are immersed in the fluid. The chamber 108 is independently vertically movable between the risen position and a lowered position through a scaled opening in the bottom wall of the host structure 104.

In order to prevent fluid from entering the basin, the scaled opening includes a chamber valve seal 140 extending around the perimeter of the scaled opening. The chamber valve seal 140 is adapted to prevent the seepage of fluid between the scaled opening and the vertically moveable chamber 108, while the chamber 108 remains vertically moveable within the scaled opening. The chamber valve seal 140 may be constructed of any suitable material, such that the coefficient of friction between the chamber valve seal 140 and the chamber 108 is just sufficient to prevent water passage into the chamber but permit an almost unhindered vertical movement of the chamber. The chamber valve seal 140 may be a dynamic seal.

FIG. 1 illustrates a first stage of an energy production cycle. The conduit valve 126 is closed which prevents fluid from entering the chamber 108. The primary valves 112 are open and the chamber valves 120 are closed. The chamber 108 is empty and buoyantly biased to the risen position. By buoyantly biased, it is meant that the empty chamber 108 is neutrally buoyant at the risen position or positioned to immerse the chamber valves 120 such that a downward gravitational force on the chamber 108 is equal or slightly less than equal to the upward buoyant force on the chamber 108. The pressure of the fluid exerted on the chamber 108 is directly proportional to the depth of the fluid. The deeper the depth, the greater the pressure of the fluid.

The chamber 108 may comprise a hollow weight member 132 to adjust the downward gravitational force on the chamber 108. The weight member 132 may be comprised of dense material, adjustable material such as water, or a combination. The dense material has a density greater than the fluid. The mass of the weight member 132 can be adjusted by the addition or subtraction of the adjustable material through an opening or valve. By adding adjustable material to the weight member, the total weight of the combined weight member 132 and chamber 108 is increased. This permits an empty chamber to be positioned below the surface of the fluid. By removing the adjustable material contained in the weight member, the mass of the weight member is reduced because the adjustable material is replaced with air. Thus, the total weight of the combined weight member 132 and chamber 108 is also reduced.

For example, the mass of steel comprising an empty cylindrical chamber and a cylindrical weight member is approximately 13,611,900 kg (assuming that the chamber and weight member each have 0.0508 m thick steel walls, the chamber has a radius of 16.93 m and height of 150 m, and the weight member has a radius of 24 m and height of 150 m).

If the depth of the bottom wall of the basin formed by the host structure is 300 m below the surface of a body of water, the water pressure at a 300 m depth is 3000 kPa. To calculate the force required to keep the bottom wall of the chamber buoyantly biased (neutrally buoyant) at the bottom wall of the basin, assume the downward gravitational pressure is 3000 kPa and surface area of bottom of chamber is 900 m² (π×16.93 m×16.93 m), as follows:

Force=Pressure×Area

Force=3000 kPa×900 m²

Force=2,700,000,000 N

Thus, the upward buoyant force required to keep the chamber buoyantly biased at the bottom wall of the basin is 2,700,000,000 N.
To calculate the mass of 2,700,000,000 N assume gravity is 10 m/s², as follows:

Mass=Force/Gravity

Mass=2,700,000,000 N/10 m/s²

Mass=270,000,000 kg

Thus, the mass required to buoyantly bias the chamber at 300 meters of water is 270,000,000 kg (neutrally buoyant).
Since the mass of the empty chamber and weight member is 13,611,900 kg, then the mass of the adjustable material that must be added to the weight member is 256,395,950 kg (270,000,000 kg minus 13,611,900 kg) which is approximately 256,000 meters cubed volume of water.

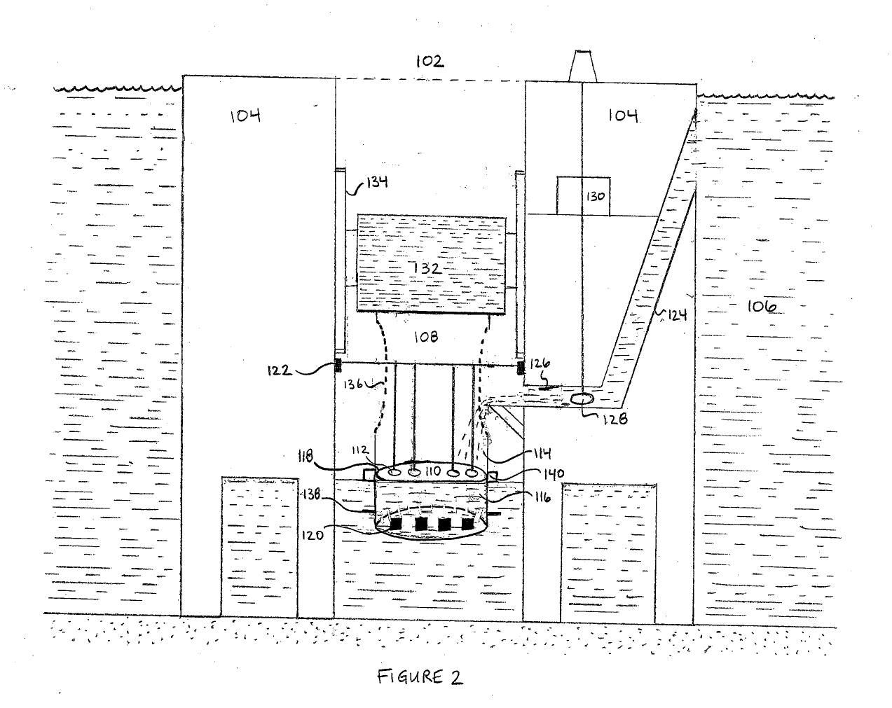

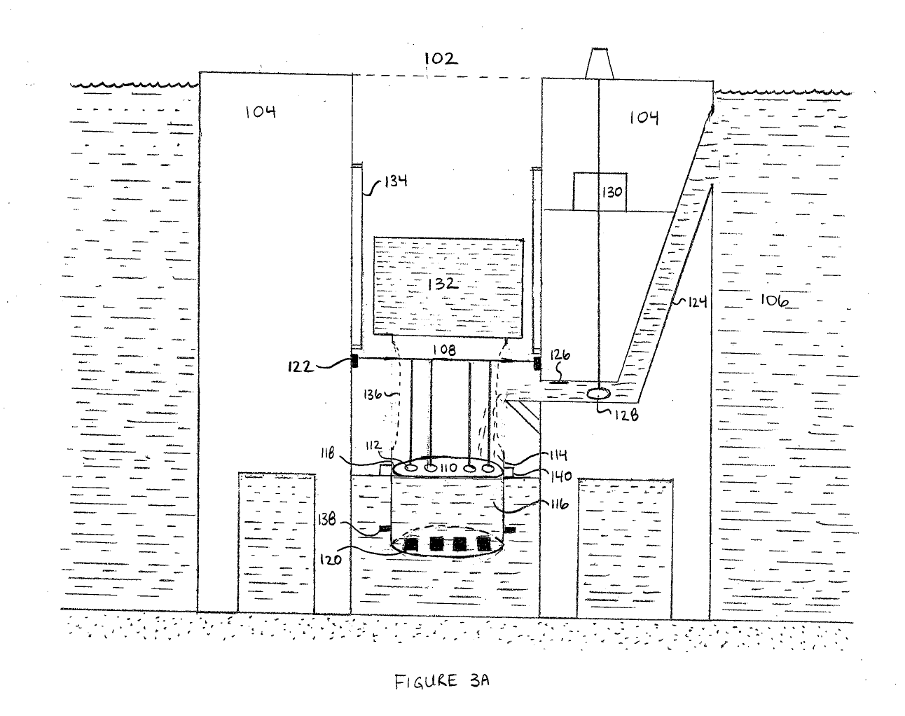

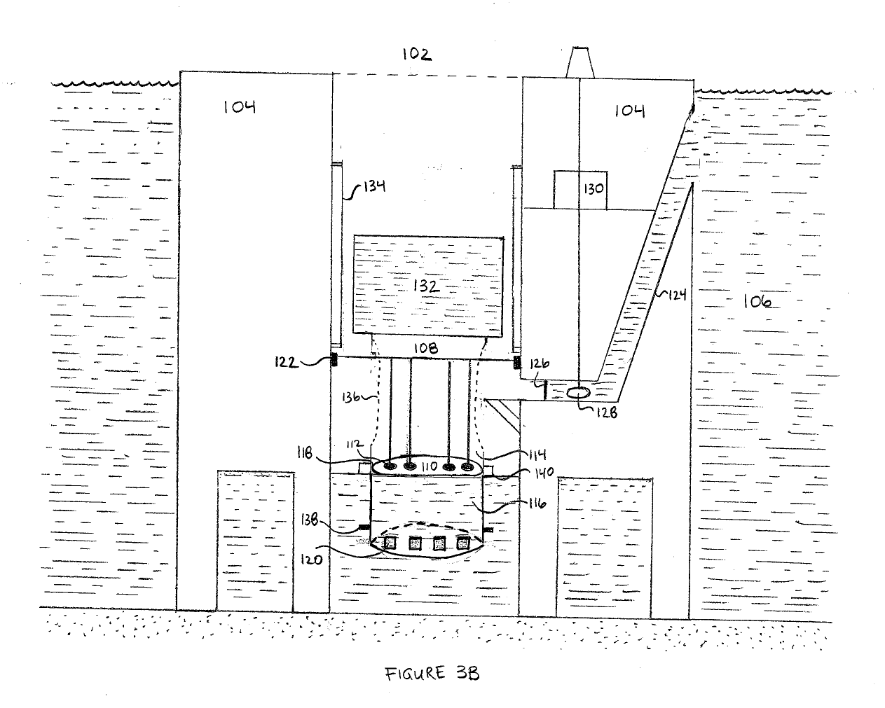

In a second stage of the energy production cycle, the conduit valve 126 is opened by the valve controls allowing fluid to enter the chamber 108. As fluid flows through the conduit 124, the energy extraction device 128 captures the kinetic energy of the falling fluid. For example, the moving fluid may spin a turbine. As illustrated in FIG. 2, the fallen fluid enters the chamber 108 and is trapped in the lower chamber portion 116. The primary valves 112 remain open and the chamber valves 120 remain closed. As the weight of the chamber 108 increases due to the fallen fluid, the chamber 108 will sink in the fluid due to the forces of gravity. The chamber 108 continues to sink until it reaches the lowered position, as illustrated in FIG. 3A. The chamber 108 sinks in the fluid an equal height as the fallen fluid in the chamber 108.

For example, the fallen fluid is water having a volume of 67,500 m³ ((π)(16.93²)(75)). To calculate the mass of the fallen water, assume that the density of water is 1000 kg/m³ and the volume of water is 67,500 m³, as follows:

Mass=Density×Volume

Mass=1000 kg/m³×67,500 m³

Mass=67,500,000 kg

The mass of the fallen water is 67,500,000 kg.
To calculate the downward gravitational force of the fallen water, assume that gravity is 10 m/s² and the mass of the fallen water is 67,500,000 kg, as follows:

Force=Mass×Gravity

Force=67,500,000 kg×10 m/s²

Force=675,000,000 N

Thus, the downward gravitational force of the fallen water is 675,000,000 N.
Assume that the downward gravitational force of an empty chamber and the weight member with approximately 256,395,950 kg of adjustable material is 2,700,000,000 N which is distributed over the 900 square meter area of the bottom of the empty chamber wall. When the chamber is filled with the fallen water, to determine the pressure acting on the bottom of the chamber at the sunken position, assume the force of the empty chamber and weight member is 2,700,000,000 N, the force of fallen water is 675,000,000 N and the surface area is 900 m², as follows:

Pressure_{chamber bottom}=(F₁+F₂)/Area

Pressure_{chamber bottom}=(2,700,000,000 N+675,000,000 N)/900 m²

Pressure_{chamber bottom}=3750 kPa

Thus, the downward gravitational pressure acting on the bottom of the sunken chamber is 3750 kPa. Assuming that the sunken chamber is neutrally buoyant, the upward buoyant water pressure is also 3750 kPa. Thus, the bottom of the sunken chamber is at a depth 375 m. Because the starting depth of the chamber is 300 m, the chamber has sunk 75 m, which is equivalent to the height of the fallen water. The fallen water is now below the primary valve member and the bottom wall of the basin, and submerged in the body of water below the basin.

In a third stage of the energy production cycle, the chamber 108 reaches the lowered position. As illustrated in FIG. 3B, once the chamber 108 sinks to the lowered position, the conduit valve 126 is closed which prevents further fluid from entering the chamber 108. The primary valves 112 are closed to trap fluid in the lower chamber portion 116 and chamber valves 120 are opened to permit fluid in the lower chamber portion 116 to flow out of the lower chamber portion 116. Upward buoyant forces acting on the chamber assist fluid to flow out of the chamber 108. The chamber 108 is pushed upward by the buoyant forces which squeeze the fluid in the lower chamber portion 116 between the primary valve member 110 and the bottom surface of the chamber. Thus, the fluid in the lower chamber portion 116 flows out of the chamber 108 through the chamber valves 120. The upward buoyant pressure has the capacity to push the chamber upward to the risen position.

To ensure that the upward buoyant forces acting on the chamber are sufficient to permit fluid to flow out of the lower chamber portion 116, the chamber 108 should not be filled with fluid to full capacity. The chamber 108 should have a significant volume that is void of fluid to retain a net upward buoyancy. Preferably, at a minimum, half of the chamber 108 is void of fluid. The weight member may provide net upward buoyancy by removing the adjustable material contained in the weight member.

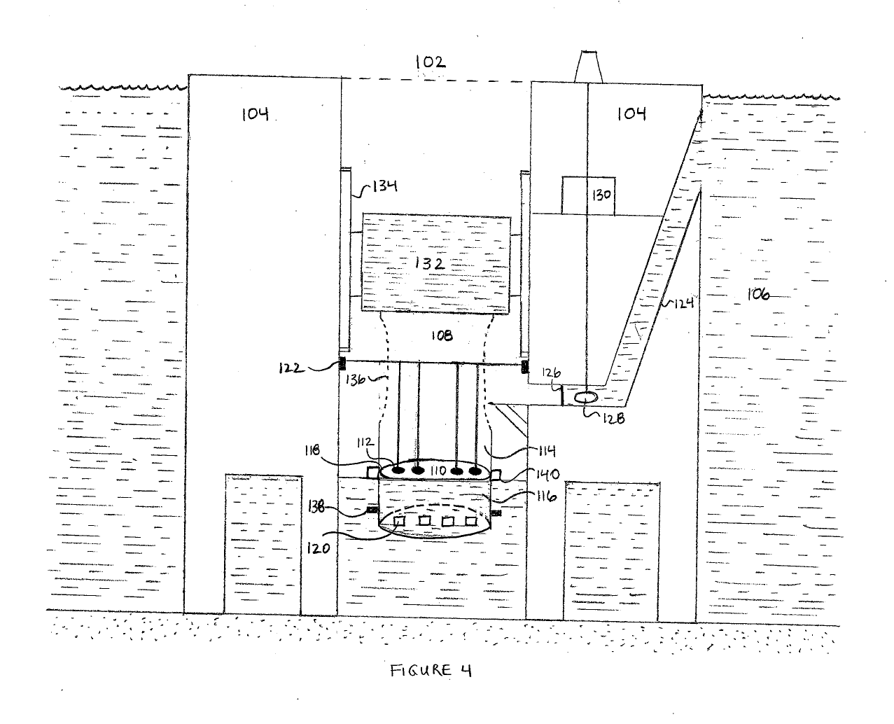

FIG. 4 illustrates a fourth stage of the energy production cycle. As the fluid in the lower chamber portion 116 flows out, the chamber 108 rises to the risen position and returns to the first stage. The energy producing unit 102 is ready to start another energy production cycle.

In order to open and close the primary valves 112, chamber valves 120 and conduit valve 126, controls may be provided.

To limit vertical movement of the chamber 108, a plurality of stops 138 may be provided on the outer surface of the lower chamber portion 116. The stops 138 are positioned to maintain the chamber valves 120 immersed in the fluid when the chamber 108 is in the risen position.

Because vertical movement of the chamber 108 may be hampered by wind, waves or other forces, a plurality of stabilizers 134 may be provided on the host structure 104 and connected to the chamber 108 or the weight member 132 to stabilize the vertical orientation of the chamber 108. The stabilizers 134 may be constructed of any suitable material, such that the coefficient of friction between the stabilizers 134 and the chamber 108 or the weight member 132 is just sufficient to permit an almost unhindered vertical movement of the chamber. A lift may also be provided to assist the chamber 108 to vertically move from the lowered position to the risen position. The lift may be useful for maintenance purposes or where unforeseen variables may temporarily hinder the upwards movement of the chamber. A lift includes lifting machines such as hoists, cranes, jacks, pulley systems, gears and may be pneumatically, hydraulically, electric or manually operated. In order to vertically move the chamber, controls may be provided.

A second energy extraction device may be disposed on the outer surface of the chamber 108. As the chamber 108 rises in the fluid, the second energy extraction device may capture energy from the movement of the chamber in the fluid. The second energy extraction device may be connected to a generator for generating electricity.

The support frame 122 may be suspended from above the host structure, or anchored adjacent to the host structure.

The fluid 106 may be water.

Because the chamber valves 120 are immersed, to permit easier access for maintenance of the chamber, a partition may be provided below the bottom wall of the basin. The partition may open and close to isolate the area below the bottom wall of the basin from the main body of fluid. This isolation may depressurize the water isolated below the bottom wall of the basin. In order to open and close the partition, controls may be provided.

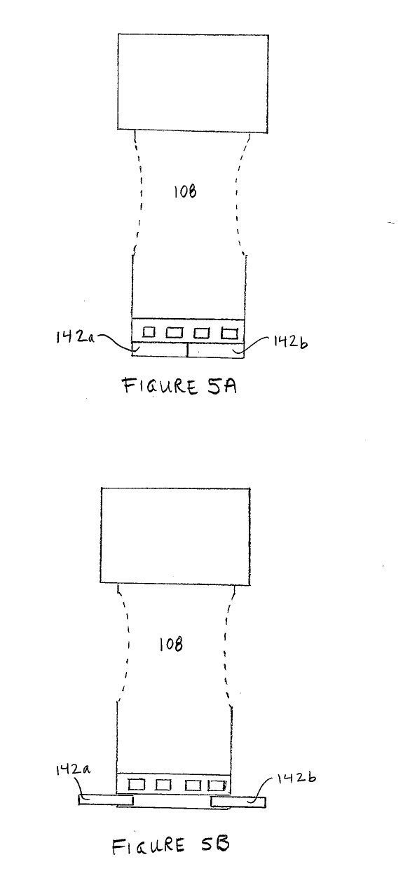

To decrease the downward gravitational pressure acting on the top side of the chamber bottom 108, the chamber may have retractable expansion wings 142a,142b disposed on the bottom surface of the chamber, as illustrated in FIGS. 5A and 5B. FIG. 5A shows the retractable expansion wings 142a,142b in a retracted position. When the chamber 108 is in the lowered position, the expansion wings 142a,142b horizontally advance to increase the surface area of the chamber bottom, as illustrated in FIG. 5B.

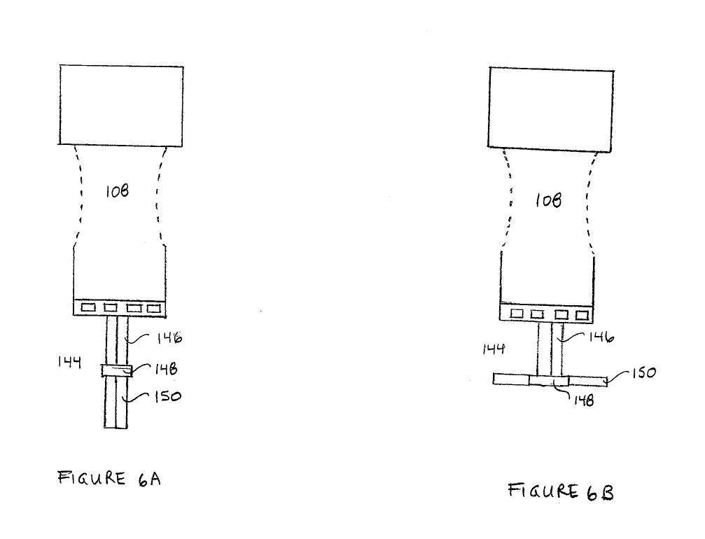

To increase the upward buoyant forces acting on the chamber 108, the chamber may have an expansion arm 144 extending below the chamber, as illustrated in FIGS. 6A and 6B. The expansion arm may include an upper portion 146 vertically affixed to the bottom side of the chamber, as illustrated in FIG. 6A. An elbow 148 may connect the upper arm portion 146 with a lower arm portion 150. When the chamber is in the lowered position, the lower arm portion 150 extends to increase the surface area of the vertical extension, as illustrated in FIG. 6B. Greater upward buoyant forces will act on the horizontal lower arm portion 150 since it is submerged at a deeper fluid pressure than the bottom of the chamber. It is contemplated that the lower arm portion may extend by the use of expansion wings which horizontally advance.

In order to expand and retract the expansion wings 142a,142b and expansion arm 144, controls may be provided.

The expansion wings 142a, 142b and expansion arm 144 increase the total surface area of the chamber bottom which spreads the downward gravitational force of the mass of the chamber over a larger area. Thus, the downward pressure on the bottom of the chamber is reduced. The larger surface area of the chamber may result in increased upward net buoyant force acting on the chamber.

For example, assume that the chamber bottom is in the lowered position at 375 metres or 3750 Kpa and the chamber bottom is neutrally buoyant because the pressure on the chamber's bottom is also 3750 Kpa ([2,700,000,000N+675,000,000N]/900 sq m). If the expansion wings 142a, 142b are horizontally extended by 0.5 meters and the compartment housing the wings on the bottom of the chamber is square with a 30×30 meter area (height is 1 meter), then the bottom of the chamber now has an area of 915 (30×30.5) square meters. The downward pressure experienced by the chamber bottom is 369 Kpa (3,375,000,000 N/915 square meters). Since the downward pressure of the entire chamber is 369 Kpa and water pressure at 375 meters is 3750 Kpa, the chamber will rise. As the chamber rises, fluid exits the chamber. Since the chamber bottom has a surface of 915 square meters, the empty chamber can rise to a depth of 295 meters (2,700,000,000N/915 sq m). As the chamber rises to its original risen position of 300 meters, the expansion wings should be retracted.

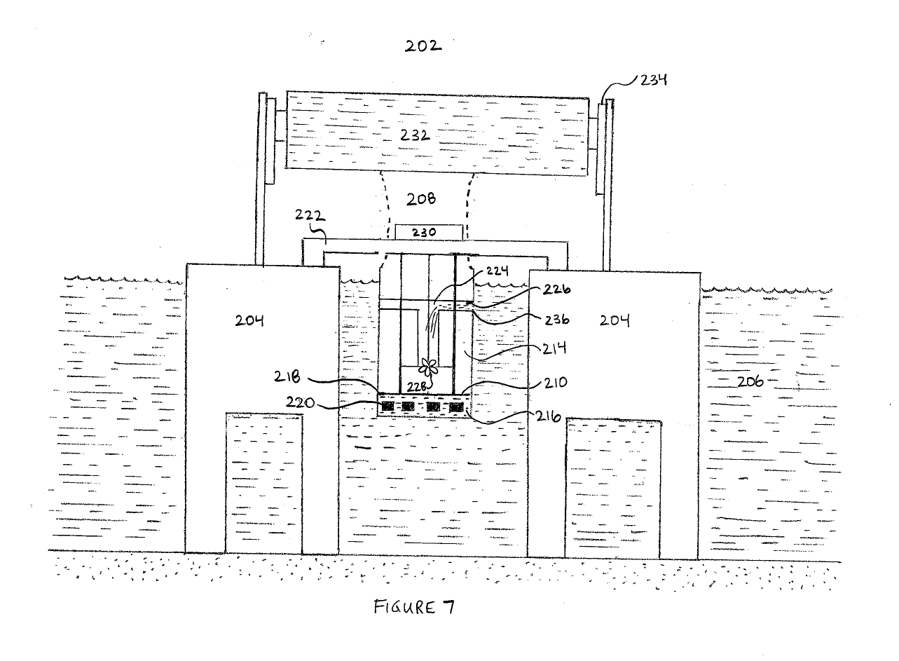

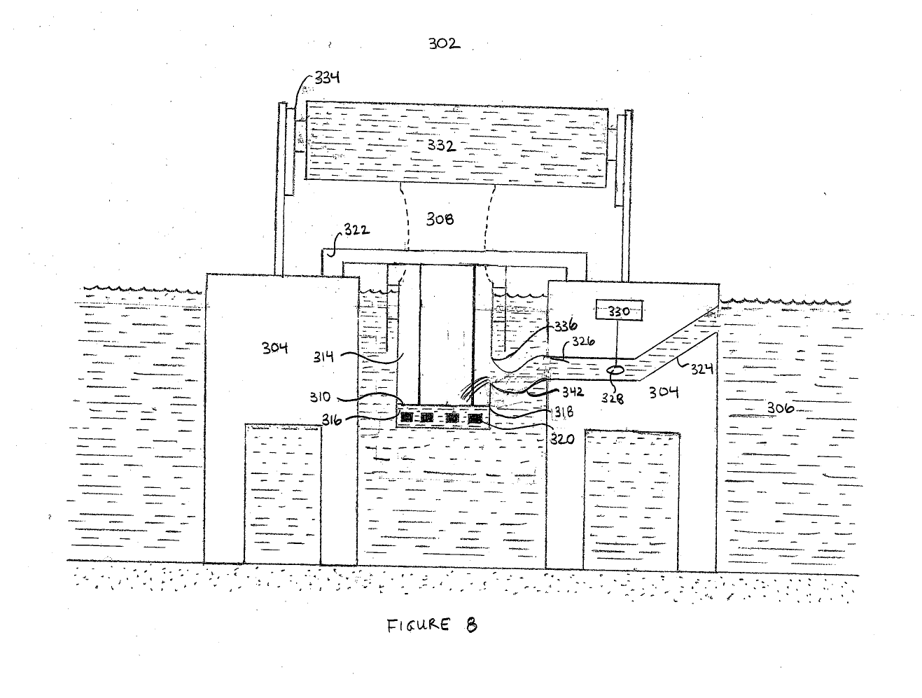

FIGS. 7 to 9 illustrate two other possible embodiments of the energy producing unit.

FIG. 7 shows a cross-sectional view of an energy producing unit 202 according to a second embodiment of the present invention. The energy producing unit 202 has a host structure 204 comprised of two sidewalls. The host structure 204 is immersed in a fluid 206. A chamber 208 is positioned within the host structure 204 and immersed in the fluid 206.

A primary valve member 210 is located within the chamber 208 and divides the chamber 208 into an upper chamber portion 214 and a lower chamber portion 216. The primary valve member 210 includes primary valves to trap fallen fluid in the lower chamber portion 216 when closed and to allow fluid to flow from the upper chamber portion 214 to the lower chamber portion 216 when open. The upper chamber portion 214 has a chamber opening 236 to permit the flow of fluid into the chamber 208.

In order to seal the fluid in the lower chamber portion 216, the primary valve member 210 which is fixed within the vertically moveable chamber 208 includes a primary valve seal 218 therebetween extending around the perimeter of the primary valve member 210. The seal is adapted to prevent the seepage of fluid between the primary valve member 210 and the chamber 208, while the chamber 208 remains vertically moveable. The primary valve seal 218 may be constructed of any suitable material, such that the coefficient of friction between the primary valve seal 218 and the chamber 208 is just sufficient to prevent water passage between the upper and lower portions of the chamber but permit an almost unhindered vertical movement of the chamber. The primary valve seal 218 may be a dynamic seal.

A conduit 224 is in fluid communication with the upper chamber portion 214 at a first end and passes through the chamber opening 236 in the upper chamber portion 214. At the other end, the conduit 224 is in fluid communication with the fluid to allow fluid to flow into the chamber 208. A conduit valve 226 is attached to the conduit 224 to control the flow of the fluid into the chamber 208 through the chamber opening 236. The conduit valve 226 may be placed anywhere within the conduit 224.

A support frame 222 is fixed to the sidewalls of the host structure 204 at one end. The support frame 222 is connected to the primary valve member 210 at the other end and holds the primary valve member 210 in a fixed position within the chamber 208.

Chamber valves 220 are located in the lower chamber portion 216 to trap fallen fluid in the chamber 208 when closed and to allow fluid to drain from the chamber 208 when open.

An energy extraction device 228 is positioned within the conduit 224 to extract kinetic energy as the fluid flows through the conduit 224 into the chamber 208. The energy extraction device 228 may be a turbine or device for capturing kinetic energy. The energy extraction device 228 may be placed anywhere within the conduit 224.

The energy extraction device 228 may be connected to a generator 230 for generating electricity. The energy extraction device 228 may also be connected to a device for direct energy consumption.

When the chamber 208 is empty, the chamber is buoyantly biased to a risen position and the chamber valves 220 are immersed in the fluid. The chamber 208 is independently vertically movable between the risen position and a lowered position.

The chamber 208 may comprise a weight member 232 to adjust the downward gravitational force on the chamber 208. The weight member 232 may be comprised of dense material, adjustable material such as water, or a combination. The dense material has a density greater than the fluid. The weight member 232 can be adjusted by the addition or subtraction of the adjustable material through an opening or valve. By adding adjustable material to the weight member, the total weight of the combined weight member 232 and chamber 208 is increased. This permits an empty chamber to be positioned below the surface of the fluid.

In order to open and close the primary valves, chamber valves 220 and conduit valve 226, controls may be provided.

Because vertical movement of the chamber 208 may be hampered by wind, waves or other forces, a plurality of stabilizers 234 may be provided on the host structure 204 and connected to the chamber 208 or the weight member 232 to stabilize the vertical orientation of the chamber 208. The stabilizers 234 may be constructed of any suitable material, such that the coefficient of friction between the stabilizers 234 and the chamber 208 or the weight member 232 is just sufficient to permit an almost unhindered vertical movement of the chamber. A lift may also be provided to assist the chamber 208 to vertically move from the lowered position to the risen position. The lift may be useful for maintenance purposes or where unforeseen variables may temporarily hinder the upwards movement of the chamber. A lift includes lifting machines such as hoists, cranes, jacks, pulley systems, gears and may be pneumatic, hydraulic electric or manually operated. In order to vertically move the chamber, controls may be provided.

A second energy extraction device may be disposed on the outer surface of the chamber 208. As the chamber 208 rises in the fluid, the second energy extraction device may capture energy from the movement of the chamber in the fluid. The second energy extraction device may be connected to a generator for generating electricity.

The support frame 222 may be suspended from above the host structure 204, or anchored adjacent to the host structure 204.

The fluid 206 may be water.

To decrease the downward gravitational pressure acting on the top side of the chamber bottom, the chamber may have retractable expansion wings disposed on the bottom surface of the chamber. When the chamber is in the lowered position, the retracted expansion wings horizontally advance to increase the surface area of the chamber bottom.

To increase the upward buoyant forces acting on the chamber, the chamber may have an expansion arm extending below the chamber. The expansion arm may include an upper portion vertically affixed to the bottom side of the chamber, and an elbow may connect the upper arm portion with a lower arm portion. When the chamber is in the lowered position, the lower arm portion extends to increase the surface area of the vertical extension. Greater upward buoyant forces will act on the horizontal lower arm portion since it is submerged at a deeper fluid pressure than the bottom of the chamber. It is contemplated that the lower arm portion may extend by the use of expansion wings which horizontally advance.

In order to expand and retract the expansion wings and expansion arm, controls may be provided.

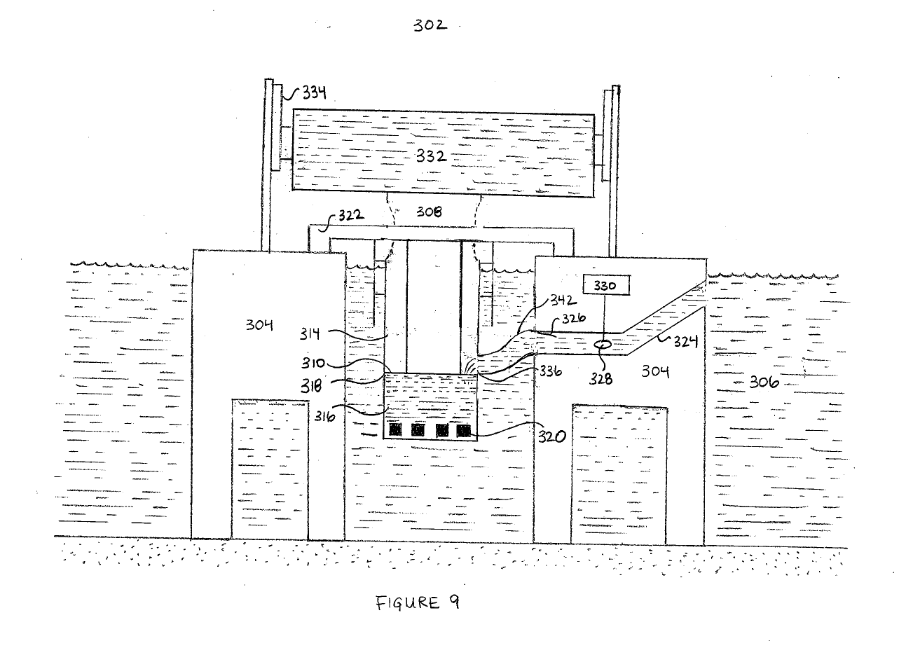

FIGS. 8 and 9 show a cross-sectional view of an energy producing unit 302 according to a third embodiment. The energy producing unit 302 has a host structure 304 comprised of two sidewalls. The host structure 304 is immersed in a fluid 306. A chamber 308 is positioned within the host structure and immersed in the fluid 306.

A primary valve member 310 is located within the chamber 308 and divides the chamber 308 into an upper chamber portion 314 and a lower chamber portion 316. The primary valve member 310 includes primary valves to trap fallen fluid in the lower chamber portion 316 when closed and to the allow fluid to flow from the upper chamber portion 314 to the lower chamber portion 316 when open. The upper chamber portion 314 has a chamber opening 336 to permit the flow of fluid into the chamber.

In order to seal the fluid in the lower chamber portion 316, the primary valve member 310, which is fixed within the vertically moveable chamber 308, includes a primary valve seal 318 therebetween extending around the perimeter of the primary valve member 310. The seal is adapted to prevent the seepage of fluid between the primary valve member 310 and the chamber 308, while the chamber 308 remains vertically moveable. The primary valve seal 318 may be constructed of any suitable material, such that the coefficient of friction between the primary valve seal 318 and the chamber 308 is just sufficient to prevent water passage between the upper and lower portions of the chamber but permit an almost unhindered vertical movement of the chamber. The primary valve seal 318 may be a dynamic seal.

A conduit 324 passes through a side wall of the host structure 304 in fluid communication with the upper chamber portion 314 at a first end and with the fluid at a second end to allow fluid to flow into the chamber 308. The conduit 324 may have a flexible or extendible portion 342 (eg. telescopic, rubber hosing or bellows tubing). The flexible portion 342 may be in fluid communication with the upper chamber portion 314.

A conduit valve 326 is attached to the conduit 324 to control the flow of the fluid into the chamber 308 through the chamber opening 336. The conduit valve 326 may be placed anywhere within the conduit 324. A second conduit valve may be positioned at the mouth of the conduit.

A support frame 322 is fixed to the sidewalls of the host structure 304 at one end. The support frame 322 is connected to the primary valve member 310 at the other end and holds the primary valve member 310 in a fixed position within the chamber 308.

Chamber valves 320 are located in the lower chamber portion 316 to trap fallen fluid in the chamber 308 when closed and to allow fluid to drain from the chamber 308 when open.

An energy extraction device 328 is positioned within the conduit 324 to extract kinetic energy as the fluid flows through the conduit 324 into the chamber 308. The energy extraction device 328 may be a turbine or device for capturing kinetic energy. It is to be appreciated that the location of the energy extraction device 328 within the conduit 324 is adaptable such that the energy extraction device 328 may be placed anywhere within the conduit 324.

The energy extraction device 328 may be connected to a generator 330 for generating electricity. The energy extraction device 328 may also be connected to a device for direct energy consumption.

When the chamber 308 is empty, the chamber is buoyantly biased to a risen position and the chamber valves 320 are immersed in the fluid. The chamber 308 is independently vertically movable between the risen position and a lowered position.

The chamber 308 may comprise a weight member 332 to adjust the downward gravitational force on the chamber 308. The weight member 332 may be comprised of dense material, adjustable material such as water, or a combination. The dense material has a density greater than the fluid. The weight member 332 can be adjusted by the addition or subtraction of the adjustable material through an opening or valve. By adding adjustable material to the weight member, the total weight of the combined weight member 332 and chamber 308 is increased. This permits an empty chamber to be positioned below the surface of the fluid.

In order to open and close the primary valves 312, chamber valves 320 and conduit valve 326, controls may be provided.

Because vertical movement of the chamber 308 may be hampered by wind, waves or other forces, a plurality of stabilizers 334 may be provided on the host structure 304 and connected to the chamber 308 or the weight member 332 to stabilize the vertical orientation of the chamber 308. The stabilizers 334 may be constructed of any suitable material, such that the coefficient of friction between the stabilizers 334 and the chamber 308 or the weight member 332 is just sufficient to permit an almost unhindered vertical movement of the chamber. A lift may also be provided to assist the chamber 308 to vertically move from the lowered position to the risen position. The lift may be useful for maintenance purposes or where unforeseen variables may temporarily hinder the upwards movement of the chamber. A lift includes lifting machines such as hoists, cranes, jacks, pulley systems, gears and may be pneumatic, hydraulic electric or manually operated. In order to vertically move the chamber, controls may be provided.

A second energy extraction device may be disposed on the outer surface of the chamber 308. As the chamber rises in the fluid, the second energy extraction device may capture energy from the movement of the chamber in the fluid. The second energy extraction device may be connected to a generator for generating electricity.

The support frame 322 may be suspended from above the host structure, or anchored adjacent to the host structure 304.

The fluid 306 may be water.

To decrease the downward gravitational pressure acting on the top side of the chamber bottom, the chamber may have retractable expansion wings disposed on the bottom surface of the chamber. When the chamber is in the lowered position, the retracted expansion wings horizontally advance to increase the surface area of the chamber bottom.

To increase the upward buoyant forces acting on the chamber, the chamber may have an expansion arm extending below the chamber. The expansion arm may include an upper portion vertically affixed to the bottom side of the chamber, and an elbow may connect the upper arm portion with a lower arm portion. When the chamber is in the lowered position, the lower arm portion extends to increase the surface area of the vertical extension. Greater upward buoyant forces will act on the horizontal lower arm portion since it is submerged at a deeper fluid pressure than the bottom of the chamber. It is contemplated that the lower arm portion may extend by the use of expansion wings which horizontally advance.

In order to expand and retract the expansion wings and expansion arm, controls may be provided.

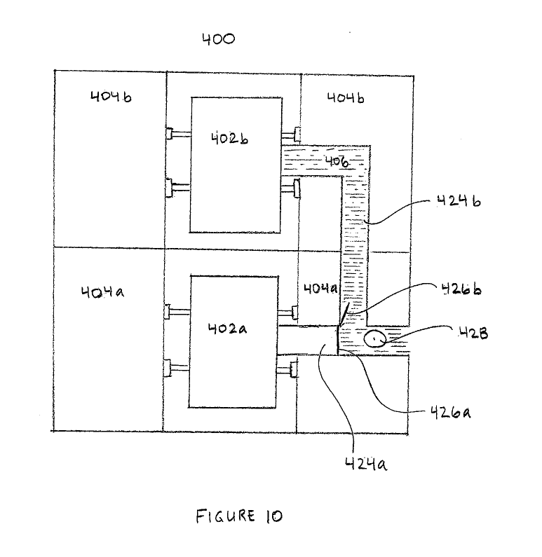

An energy producing structure 400 is illustrated in FIG. 10. FIG. 10 illustrates a top view of the energy producing structure 400 having two energy producing units 402a, 402b. The energy producing structure 400 permits continuous energy production by staggering energy production cycles of energy producing units 402a, 402b to permit an energy extraction device 428 to continuously extract kinetic energy from falling fluid 406. For example, as a first energy producing unit 402a rises to a risen position, the other energy producing unit 402b sinks to a lowered position. The energy producing structure 400 has two conduits 424a, 424b in sidewalls of the host structure 404a, 404b, respectively. Two conduit valves 426a, 426b control the flow of fluid between energy producing units 402a, 402b, respectively. To improve control of fluid, a third conduit valve may be positioned at the mouth of the conduit. A second energy extraction device may be provided such that an energy extraction device is positioned in each of the conduits 424a, 424b.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims.

What is claimed is:

1. An energy producing unit comprising:
a host structure immersed in a fluid, the host structure having at least one side wall and a bottom wall;
a chamber having a bottom wall, the chamber positioned relative to the host structure such that the bottom wall of the chamber is immersed, the chamber being independently vertically movable relative to the host structure between a risen position and a lowered position through a scaled opening in the bottom wall of the host structure, the scaled opening having a fluid seal, the chamber being buoyantly biased to the risen position when empty;
a primary valve member having a primary valve and a fluid seal, the primary valve member disposed within the chamber in a fixed position relative to the host structure to divide the chamber into an upper portion and a lower portion, the fluid seal disposed between the primary valve member and the chamber, such that when the primary valve is open, fluid may pass between the upper and lower portions and when closed, prevents fluid communication between such portions;
a chamber valve in the lower portion of the chamber for draining fluid from the chamber;
a conduit having a first end and a second end, the conduit passes through the at least one side wall of the host structure, the conduit in fluid communication with the upper portion of the chamber at the first end and open to the exterior of the chamber at the second end, the conduit permitting fluid located outside the chamber to flow into the upper portion of the chamber, the conduit having at least one conduit valve for controlling the flow of the fluid into the chamber;
an energy extraction device disposed within the conduit to extract kinetic energy as fluid flows through the conduit into the chamber; and
a support frame disposed relative to the host structure to support the primary valve member in a fixed position relative to the host structure without interfering with the movement of the chamber;
wherein, when the chamber is in the risen position and fluid fills the chamber, by opening the primary valve, the chamber sinks due to its increased weight to the lowered position,
and wherein, when the chamber is in the lowered position, by closing the primary valve and opening the chamber valve, fluid drains from the chamber, and the chamber rises due to buoyant forces to the risen position.

2. The energy producing unit of claim 1, wherein the chamber is immersed within the host structure.

3. The energy producing unit of claim 1, further comprising a partition provided below the bottom wall of the basin to isolate the area below the bottom wall of the basin from the main body of fluid.

4. The energy producing unit of claim 1, wherein the chamber further comprises a weight member to adjust a downward gravitational force on the chamber.

5. The energy producing unit of claim 1, further comprising stabilizers affixed to the host structure to stabilize vertical movement of the chamber.

6. The energy producing unit of claim 1, wherein the conduit has a flexible portion in communication with the upper portion of the chamber.

7. The energy producing unit of claim 1, wherein the conduit has an extendible portion in communication with the upper portion of the chamber.

8. The energy producing unit of claim 1, wherein the energy extraction device comprises a turbine.

9. The energy producing unit of claim 1, wherein the energy extraction device is connected to a generator for generating electrical energy.

10. The energy producing unit of claim 1, wherein the support frame is disposed within the host structure.

11. The energy producing unit of claim 1, wherein the support frame is suspended within the host structure.

12. The energy producing unit of claim 1, wherein the support frame is affixed to the host structure.

13. The energy producing unit of claim 1, wherein the support frame is anchored adjacent to the host structure.

14. The energy producing unit of claim 1, wherein the fluid is water.

15. The energy producing unit of claim 1, further comprising a lift to assist the chamber to vertically move from the lowered position to the risen position.

16. The energy producing unit of claim 1, wherein the chamber further comprises a second energy extraction device disposed on the outer surface of the chamber.

17. The energy producing unit of claim 16, wherein the second energy extraction device is connected to a generator for generating electrical energy.

18. The energy producing unit of claim 1, wherein the chamber further comprises expansion wings disposed on the bottom surface of the chamber.

19. The energy producing unit of claim 1, wherein the chamber further comprises an expansion arm vertically affixed to the bottom surface of the chamber.

20. The energy producing unit of claim 1, further comprising controls.

21. An energy producing unit comprising:
a host structure immersed in a fluid;
a chamber having a bottom wall, the chamber positioned relative to the host structure such that the bottom wall of the chamber is immersed, the chamber being independently vertically movable relative to the host structure between a risen position and a lowered position, the chamber being buoyantly biased to the risen position when empty;
a primary valve member having a primary valve and a fluid seal, the primary valve member disposed within the chamber in a fixed position relative to the host structure to divide the chamber into an upper portion and a lower portion, the fluid seal disposed between the primary valve member and the chamber, such that when the primary valve is open, fluid may pass between the upper and lower portions and when closed, prevents fluid communication between such portions;
a chamber valve in the lower portion of the chamber for draining fluid from the chamber;
a conduit having a first end and a second end, the conduit in fluid communication with the upper portion of the chamber at the first end and open to the exterior of the chamber at the second end, the conduit permitting fluid located outside the chamber to flow into the upper portion of the chamber, the conduit having at least one conduit valve for controlling the flow of the fluid into the chamber;
an energy extraction device disposed within the conduit to extract kinetic energy as fluid flows through the conduit into the chamber; and
a support frame disposed relative to the host structure to support the primary valve member in a fixed position relative to the host structure without interfering with the movement of the chamber;
wherein, when the chamber is in the risen position and fluid fills the chamber, by opening the primary valve, the chamber sinks due to its increased weight to the lowered position,
and wherein, when the chamber is in the lowered position, by closing the primary valve and opening the chamber valve, fluid drains from the chamber, and the chamber rises due to buoyant forces to the risen position.

22. The energy producing unit of claim 21, wherein the chamber is immersed within the host structure.

23. The energy producing unit of claim 21 wherein the host structure further comprises at least one side wall and the conduit passes through the at least one side wall of the host structure.

24. An energy producing structure comprising:
at least two energy producing units, each energy producing unit comprising:
a host structure having at least one side wall, the host structure immersed in a fluid;
a chamber having a bottom wall, the chamber positioned relative to the host structure such that the bottom wall of the chamber is immersed, the chamber being independently vertically movable relative to the host structure between a risen position and a lowered position, the chamber buoyantly biased to the risen position when empty;
a primary valve member having a primary valve and a fluid seal, the primary valve disposed within the chamber in a fixed position relative to the host structure to divide the chamber into an upper portion and a lower portion, the fluid seal disposed between the primary valve member and the chamber, such that when the primary valve is open, fluid may pass between the upper and lower portions and when closed, prevents fluid communication between such portions;
a chamber valve in the lower portion of the chamber such that the chamber valve is immersed for draining fluid from the chamber;
a support frame affixed to the host structure to support at least one primary valve member in a fixed position relative to the host structure without interfering with the movement of the chamber; and
a weight member affixed to the chamber to adjust a downward gravitational force on the chamber;
at least two conduits passing through the at least one side wall of the host structure, each conduit having a first end and a second end, a first conduit in fluid communication with the upper portion of the chamber at the first end and open to the exterior of a first chamber at the second end, a second conduit in fluid communication with the first conduit at the first end and open to the exterior of a second chamber at the second end, the at least two conduits permitting fluid located outside the chamber to flow into the upper portion of the chambers, the at least two conduits having at least one valve for controlling the flow of the fluid into the chamber; and
at least one energy extraction device disposed within the at least two conduits to extract kinetic energy as fluid flows through the at least two conduits into the chambers;
wherein, when the chambers are in the risen position and fluid fills the chambers, by opening the primary valve, the chambers sinks due to their increased weight to the lowered position,
and wherein, when the chambers are in the lowered position, by closing the primary valve and opening the chamber valve, fluid drains from the chambers, and the chambers rise due to buoyant forces to the risen position.

25. The energy producing system of claim 24, wherein the host structure of each energy producing unit further comprises a bottom wall and the chamber of each energy producing unit moves from the risen position to the lowered position through a scaled opening in the bottom wall of the host structure, the scaled openings having fluid seals.

26. The energy producing structure of claim 24, wherein the second ends of the conduits have a flexible portion in communication with the upper portion of the chamber.

27. The energy producing structure of claim 24, wherein the second ends of the conduits have an extendible portion in communication with the upper portion of the chamber.

28. The energy producing structure of claim 24, further comprising stabilizers affixed to the host structure of each energy producing unit to stabilize vertical movement of the chamber.

29. The energy producing structure of claim 24, further comprising controls.
